(19) United States
(12) Patent Application Publication
(10) Pub. No.: US 2016/0237637 A1
(43) Pub. Date: Aug. 18, 2016

(54) Soil Stabilization System and Method

(71) Applicant: Caterpillar Paving Products Inc., Brooklyn Park, MN (US)

(72) Inventors: Brian Joe Schlenker, Shoreview, MN (US); Jason William Muir, Andover, MN (US); Eric Engelmann, Delano, MN (US)

(73) Assignee: Caterpillar Paving Products Inc., Brooklyn Park, MN (US)

(21) Appl. No.: 14/623,373

(22) Filed: Feb. 16, 2015

(51) Int. Cl. E02D 3/12; C09K 17/02

(52) U.S. Cl. CPC E02D 3/126; C09K 17/02

(57) ABSTRACT

Soil stabilization systems and methods for stabilization of a ground surface are disclosed. The systems and methods may include a stabilization machine having a mixing chamber, a dry additive deliver system for delivering dry additive from a dry additive storage truck and a water delivery system for delivering water from a water storage truck. The systems and methods may further include the delivery of dry additive and water directly to the mixing chamber of a stabilization machine.

### TECHNICAL FIELD

The present disclosure generally relates to soil stabilization machines and, more particularly, relates to a system for the addition of dry additives and water directly to the mixing chamber of a stabilization machine during operation.

### BACKGROUND

Soil stabilization is the process of mechanically or chemically improving the load-bearing capacity of soil or a ground surface. The process of soil stabilization may be required where roads are constructed for vehicular travel, as well as for building pads on which other construction may take place. In addition, soil stabilization may be useful in other applications, including surface mining, bio-remediation, agriculture and the building of high strength haul roads.

Stabilization machines such as rotary mixers typically include a frame quadrilaterally supported on traction units, an engine, an operator's station and a hood member under which a milling/mixing rotor is disposed, thereby forming an open bottom mixing chamber. A rotary mixer may be used as a soil stabilizer to cut, pulverize and mix native in-place soils with additives or aggregates that modify and stabilize the soil for a strong base. For example, dry additives such as fly ash, cement or lime may be incorporated into native soil during the stabilization process thereby increasing the general integrity of the soil. For stabilization purposes, a spreading machine is commonly used for dispensing dry additives in a layer directly over the base material or soil to be stabilized. Thereafter, a rotary mixer may pass over the coated base material to pulverize and mix the dry additive into the base material within the mixing chamber of the rotary mixer.

Dry additives used for soil stabilization purposes are typically powdery and light in nature. As a result, the stabilization method of disposing a layer of dry additive directly onto the base material before passing over the same with a stabilization machine tends to generate significant amounts of dust. This is especially true in windy conditions. Such increased dust levels at a worksite may cause undesirable conditions, such as impaired visibility within the site, diminished work machine performance and increased frequency of work machine maintenance. In addition, such dust levels may create uncomfortable work conditions for work personnel. Moreover, disturbance of the dry additive by the wind may ultimately negatively affect the amount of additive that is available for mixing with and stabilizing the soil.

Prior methods have been attempted to overcome these disadvantages of working with dry additives. For example, rather than using a spreading machine for depositing a layer of dry additive onto the base material in advance of the stabilization machine; the stabilization machine or rotary mixer itself may be equipped with an additive storage container mounted directly thereon. Such machines, having a built-in arrangement for spreading dry additives, directly dispose the additive onto the base material immediately before the mixing rotor travels over the additive and base material. However, as built-in storage containers are limited significantly with regard to the volume of dry additive they may contain, methods involving the dispersion of dry additives from such built-in storage containers require numerous refilling operations of the containers during a single stabilization process. Such methods therefore incur increased costs related to additional down time, energy consumption and personnel. Other methods involving spraying water over a disposed dry additive layer have also been attempted, however, these methods may present additional clean-up and disposal problems. Likewise, delivery of water to the mixing chamber of a stabilization machine has been employed, but fails to fully address the problems associated with dry additives. Accordingly, it would be beneficial to provide a soil stabilization system that directly delivers, proximate the mixing rotor of a stabilization machine, a relatively continuous supply of dry additive, thereby avoiding the above-described inefficiencies and undesirable working conditions, as well as dry additive loss.

### SUMMARY

In accordance with one aspect of the present disclosure, a soil stabilization machine configured to mix a ground surface with dry additive and water is disclosed which may include a machine frame, a plurality of traction units configured to support the machine frame on the ground surface and a rotor coupled to the frame between traction units and configured to engage the ground surface. The soil stabilization machine may further include a mixing chamber at least partially defined by a hood and at least partially surrounding the rotor, a dry additive delivery system configured to blow a metered amount of dry additive under the hood and directly into the mixing chamber from a dry additive storage truck and a water delivery system configured to deliver a metered amount of water directly into the mixing chamber from a water storage truck.

In accordance with another aspect of the present disclosure, a soil stabilization system configured to mix dry additive and water with a ground surface is disclosed which may include a rotary mixer including a mixing chamber, a dry additive storage truck and a water storage truck. The stabilization system may also include a dry additive conduit for delivery of dry additive from the dry additive storage truck to the mixing chamber, a water conduit for delivery of water from the water storage truck to the mixing chamber, and the rotary mixer, the dry additive storage truck and the water storage truck may be rigidly connected.

In accordance with another aspect of the present disclosure, a method of soil stabilization of a ground surface is disclosed which may include providing a stabilization machine having a mixing chamber, a dry additive storage truck and a water storage truck; and rigidly connecting the stabilization machine, the dry additive storage truck and the water storage truck. The soil stabilization method may further include operating the stabilization machine to engage the ground surface beneath the mixing chamber and to advance forward simultaneously with the dry additive storage truck and water storage truck; mixing the ground surface with a dry additive delivered from the dry additive storage truck to the mixing chamber; and mixing the ground surface with water delivered from the water storage truck to the mixing chamber.

These and other aspects and features of the present disclosure will be better understood when read in conjunction with the accompanying drawings.

### BRIEF DESCRIPTION OF THE DRAWINGS

FIG. 1 illustrates an exemplary stabilization machine, partly in section, showing the interior of a mixing chamber.

FIG. 2 is a simplified schematic representation of connections between several elements of the presently disclosed stabilization system.

FIG. 3 illustrates an exemplary combination of interconnected machines employed in the presently disclosed stabilization system.

FIG. 4 illustrates another exemplary combination of interconnected machines employed in the presently disclosed stabilization system.

FIG. 5 illustrates another exemplary combination of interconnected machines employed in the presently disclosed stabilization system.

FIG. 6 illustrates another exemplary combination of interconnected machines employed in the presently disclosed stabilization system.

FIG. 7 illustrates another exemplary combination of interconnected machines employed in the presently disclosed stabilization system.

FIG. 8 illustrates another exemplary combination of interconnected machines employed in the presently disclosed stabilization system.

FIG. 9 is a block diagram illustrating a method for soil stabilization according to the teachings of the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

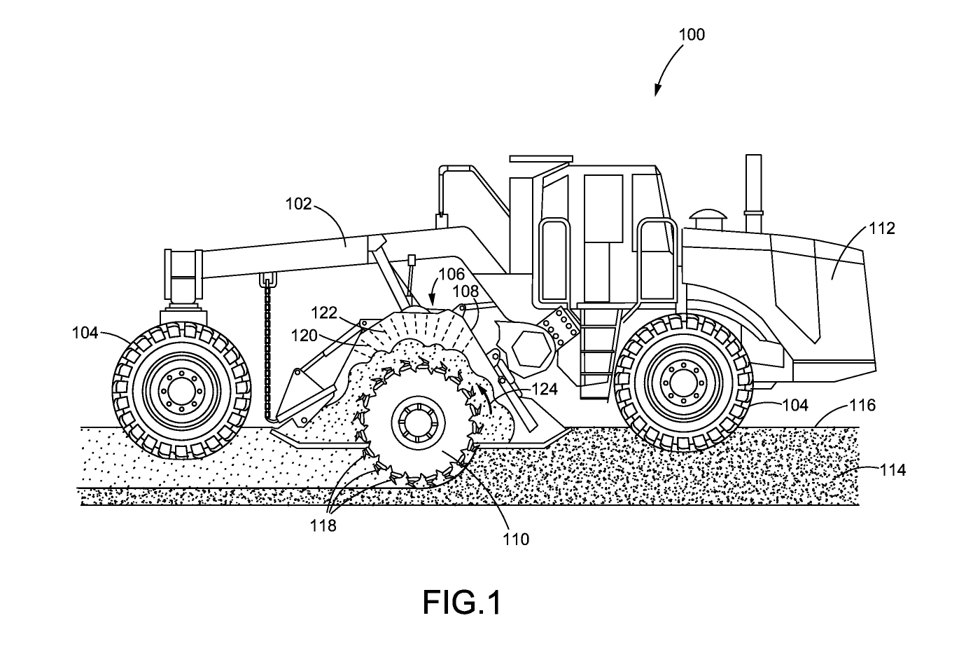

Stabilization of soil or base material pertains to the cutting and pulverizing of a base material, as well as the addition of additives and water to be mixed into the base material. FIG. 1 illustrates an exemplary stabilization machine 100, in this case, a rotary mixer. Although FIG. 1 shows a rotary mixer, any other machine used in road reclamation, soil stabilization, surface pulverization or other applications is contemplated by the present disclosure. The machine 100 may include a frame 102 connected to one or more wheel or traction units 104. Although fraction units 104 are depicted as wheels, it is to be understood that other devices, such as but not limited to tracks or the like may also be employed. According to FIG. 1, the machine 100 may also include an open bottom mixing chamber 106 positioned between the traction units 104. The mixing chamber 106 may generally extend the width of the machine 100. The mixing chamber 106 may be partially defined by a hood 108 and may include a horizontally disposed, ground engaging rotor 110 partially housed therein. An engine 112 (or other power source) may be configured to electrically, mechanically, hydraulically and/or pneumatically power the traction units 104 and the rotor 110.

The rotor 110 may include components rotationally driven by the engine 112 to pulverize a base material 114 of a ground surface 116 on which the machine 100 is operating. Ground surface 116 as used herein may include any base material 114 such as soil, dirt, gravel, sand, stones, concrete, pavement and the like. The rotor 110 may further include a plurality of cutting tools 118 spaced apart and pointed in a direction of rotation (indicated by an arrow 124) of the rotor 110, such that a tip end of each cutting tool 118 is driven into the base material 114 by the rotation of the rotor 110. As the machine 100 advances along the ground surface 116 to be stabilized, the rotor 110 and cutting tools 118 penetrate the ground surface 116 and lift the base material 114 from the surface, causing the base material 114 to move upwards into the mixing chamber 106, as indicated in FIG. 1. According to the present disclosure, allocations of dry additive 120 and water 122 are also introduced into the mixing chamber 106 where they collide with the upwardly moving base material 114. In this manner, the base material 114 is cut and pulverized within the mixing chamber 106, as well as immediately mixed with the dry additive 120 and water 122.

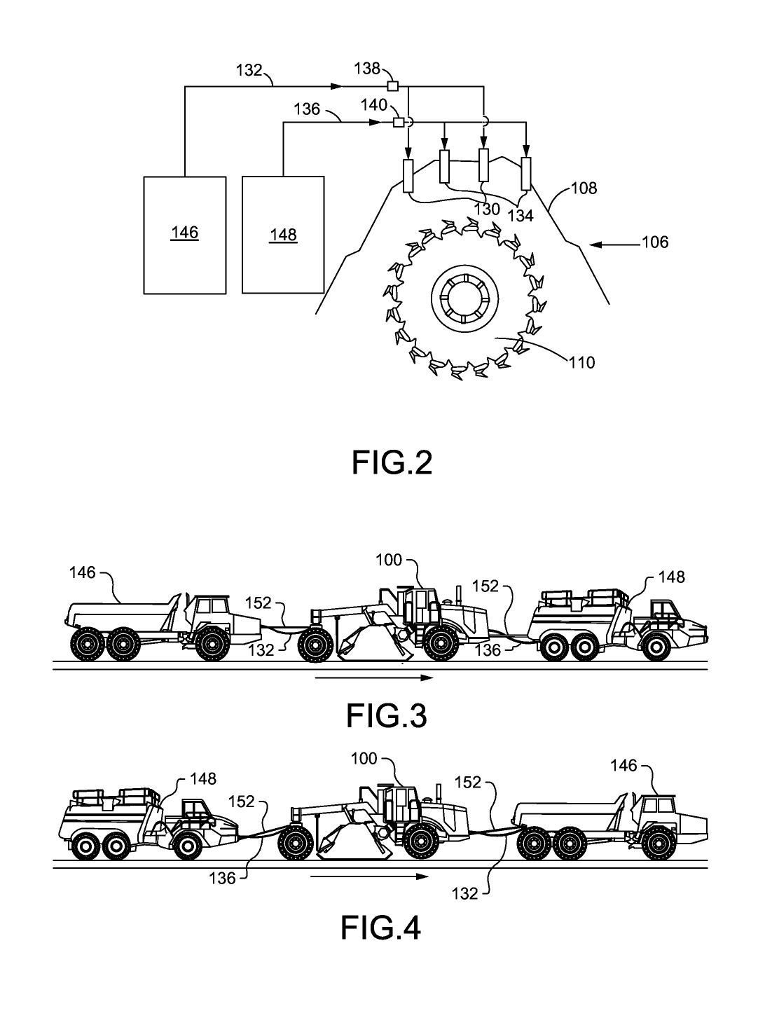

As described above, dry additives for soil stabilization may include fly ash, lime and/or cement. The addition of water 122 into the mixing chamber 106 may aid in the mixing process by wetting the pulverized base material 114 and the dry additive 120. Introduction of dry additives and water into the mixing chamber 106 may be through similar mechanisms. The hood 108 of the mixing chamber 106 may provide a support for systems such as spray bars, nozzles or other fixtures by which additives and water may be delivered to the mixing chamber 106 and mixed with the base material 114. For example, spray bars supported on the hood 108 and extending the width of the mixing chamber 106 may deliver additives and water to the interior of the mixing chamber 106. Alternatively or in addition, a series of spaced nozzles or tubes may be disposed in the hood 108 to deliver dry additives and water to the interior of the mixing chamber 106. According to the present disclosure and illustrated in FIG. 2, a dry additive delivery system 130 employed to deliver dry additive to the mixing chamber 106 may be coupled to a dry additive supply line 132. Likewise, a water delivery system 134 employed to deliver water to the mixing chamber 106 may be coupled to a water supply line 136. Various systems 130, 134 for delivering dry additives and water to the mixing chamber 106, as described above, are contemplated herein and may be spaced throughout the hood 108 of the mixing chamber 106 in any pattern that allows efficient delivery of dry additives and water across the width of the mixing chamber 106 to the subject base material 114 within the mixing chamber 106.

Several factors may influence the amount of dry additive or water to be delivered to the mixing chamber 106 and mixed with the base material 114, including: the initial characteristics of the ground surface 116 or the base material 114, the load-bearing capacity needed, the speed at which the machine 100 advances, the speed at which the rotor 110 rotates and the depth at which the rotor 110 engages the ground surface 116. In order to consistently control the amounts of dry additive and water delivered to the mixing chamber 106, metering devices 138, 140 may be coupled with the supply lines 132, 136 or the delivery systems 130, 134. Specifically, the dry additive delivery system 130 or the dry additive supply line 132 may have a metering device 138 that is the same as or different from a metering device 140 for the water delivery system 134 or the water supply line 136. Alternatively, the metering devices 138, 140 and delivery systems 130, 134 may essentially be the same component, for example, a nozzle in the hood 108 of the mixing chamber 106, the nozzle including controllable valves for metering the amounts of dry additive or water delivered to the mixing chamber 106.

The metering devices 138, 140 for controlling the volume and rate of delivery of dry additive and/or water in the disclosed soil stabilization system may include, but are not limited to, inlets, outlets, tubes, pumps, one or more rotary feeders, pressurized components, expandable components and/or one or more valves. Additionally, the metering devices 138, 140 contemplated herein may be automatically computer controlled based on the forward movement of the machine 100, on the rotation of the rotor 110 or on any other parameter such as the amount or gradation of the base material 114 estimated to exist in the mixing chamber 106 at any particular moment during operation. Alternatively, the metering devices 138, 140 may be controlled by an operator.

The disclosed stabilization system further allows for nonstop or continuous metering and delivery of dry additive and water to the base material 114 being pulverized in the mixing chamber 106 of the machine 100 during a stabilization operation. Specifically, a dry additive storage truck 146 and a water storage truck 148 may be provided for continuously supplying the stabilization machine 100 with dry additive and water. While the dry additive and water storage trucks 146, 148 of the present disclosure are generally self-propelled and include a cab for a driver, dry additive and water storage trucks 146, 148 as disclosed herein also encompass non-self-propelled apparatus, for example, a truck chassis or trailer having a dry additive or water storage container disposed thereon. As illustrated in FIG. 2, the dry additive supply line 132 couples the dry additive storage truck 146 to the dry additive delivery system 130. Likewise, the water supply line 136 couples the water storage truck 148 to the water delivery system 134. The dry additive and water supply lines 132, 136 may be similar or different in their construction and attachment to their respective storage trucks 146, 148; however, each functions as a conduit for delivery of dry additive or water to delivery systems 130, 134 and ultimately to the mixing chamber 106 of the machine 100. The dry additive and water supply lines 132, 136 may include a flexible hose, tubing or any such conduit capable of extending between and transferring contents between the storage trucks 146, 148 and the machine 100.

Water storage trucks 148 and other mobile fluid distribution systems are known in the art and may include mobile units having various combinations of actuators, pumps and valves for delivering fluid. Regarding dry additive delivery from the dry additive storage truck 146 into the dry additive supply line 132 and ultimately to the machine 100, dry additives may be fluidized and distributed using methods similar those of fluid distribution systems. Dry additive delivery from the dry additive storage truck 146 and through supply line 132 may involve pressure manipulation through the use of air compressors, fans, suction fans or pump mechanisms. Blower/impeller systems having one or more blowers may also be employed in the presently disclosed system and methods. Ultimately, a metered amount of dry additive may be blown with a fan or compressed air system under the hood and directly into the mixing chamber 106 after passing through the metering device 138 proximate the mixing chamber 106. As with the metering of dry additive and water into the mixing chamber 106, delivery of the dry additive and water from the storage trucks 146, 148 to the supply lines 132, 136, and ultimately to the mixing chamber 106, may be automatically computer controlled or controlled by an operator such that continuous delivery at a controlled rate and volume is maintained.

Turning to FIGS. 3-8, the disclosed stabilization system may further include the attachment of the stabilization machine 100, the dry additive storage truck 146 and water storage truck 148 to each other in a front to back manner. In this manner, the machine 100 and the storage trucks 146, 148 may travel or advance at the same speed and over the same ground surface 116 during the soil stabilization process. Attachment of the machine 100 and the trucks 146, 148 may include a rigid connection 152 (between the machine and truck frames) that is releasable, thereby detaching the machine 100 and the trucks 146, 148 from one another once the soil stabilization process is completed. The rigid connection 152 may be any of a number of structures known in the art for use in pulling, pushing or towing vehicles. For example, the rigid connection 152 may include a tow bar, a shank, a beam, a push/pull bar or any other rigid component that may be configured for attachment to the frames of the machine 100 and the trucks 146, 148. The rigid connection 152 should be sufficiently strong and inflexible so as to support any pressure exerted thereon during the pushing or pulling of one machine 100 or truck 146, 148 relative to another during the stabilization process. The rigid connection 152 between the machine 100 and the trucks 146, 148 may also include multiple rigid connections, including multiple bars, shanks, beams and the like.

The frames of the machine 100 and the trucks 146, 148 may be adapted with any number of structures known in the art and configured to receive the rigid connection 152, such as a hitch, hitch receiver, clamps, ball mount, coupler, chains and the like. The rigid connection 152 may be disposed at a front end or a rear end of the machine 100 and the trucks 146, 148. In this manner, the interconnected machine 100 and trucks 146, 148 are substantially “in line” in a front to back formation with one another. This presently disclosed arrangement of the stabilization machine 100 interconnected with the dry additive storage truck 146 and the water storage truck 148 may be referred to herein as a “stabilization train.”

FIGS. 3-8 illustrate various possible combinations of the machine 100 and the trucks 146, 148 of stabilization trains in accordance with the presently disclosed stabilization system. For example, as illustrated in FIGS. 3 and 4, the stabilization machine 100 may be positioned between the dry additive storage truck 146 and the water storage truck 148. Rigid connections 152 are depicted between the frame of the dry additive storage truck 146 and the stabilization machine 100, as well as between the stabilization machine 100 and the water storage truck 148. As described above, the storage trucks 146, 148 may be non-self-propelled. Therefore, due to the rigid connections 152, the water storage truck 148 and the dry additive storage truck 146 may be either pushed or pulled by the operation and advancement of the stabilization machine 100. Where self-propelled storage trucks 146, 148 are employed, the machine 100 and storage trucks 146, 148 advance at the same speed during the stabilization process due to the rigid connections 152 between the machine 100 and the storage trucks 146, 148.

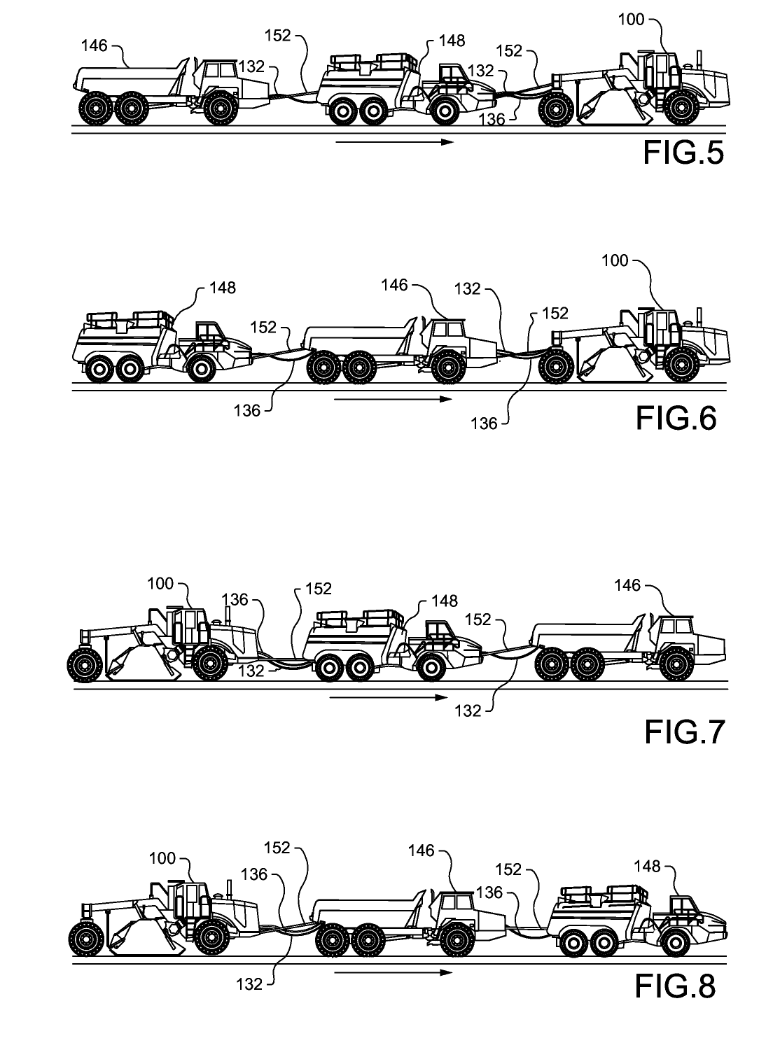

FIGS. 5 and 6 illustrate stabilization trains having the stabilization machine 100 positioned in front of both the water storage truck 148 and the dry additive storage truck 146. In these exemplary stabilization trains, the rigid connections 152 may be disposed between the stabilization machine 100 and the trucks 146, 148, as well as between the trucks 146, 148. In operation, the stabilization trains illustrated in FIGS. 5 and 6 may advance with the forward movement of the stabilization machine 100. Specifically, the machine 100 may pull or tow both the water storage truck 148 and the dry additive storage truck 146. Likewise, one or both of the storage trucks 148, 146 may be self-propelled. In either case, the machine 100 and the storage trucks 148, 146 advance forward at the same speed.

FIGS. 7 and 8 illustrate stabilization trains having the stabilization machine 100 positioned behind both the water storage truck 148 and the dry additive storage truck 146. As in FIGS. 5 and 6, the rigid connections 152 may be disposed between the stabilization machine 100 and the trucks 146, 148, as well as between the trucks 146, 148. In operation, the stabilization trains illustrated in FIGS. 7 and 8 may advance with the forward movement of the stabilization machine 100. The machine 100 may push both the water storage truck 148 and the dry additive storage truck 146. Likewise, one or both of the storage trucks 148, 146 may be self-propelled. In either case, the machine 100 and the storage trucks 148, 146 advance forward at the same speed.

While the stabilization systems illustrated in FIGS. 3-8 include only three-member systems (stabilization machine 100, dry additive storage truck 146 and water storage truck 148), stabilization systems contemplated herein may include additional members, including additional construction machines, additional storage trucks, or any additional members that may be required at a particular worksite. All such machines or members may be either self-propelled or non-self-propelled, and adapted for interconnecting through rigid connections 152 with additional machines or members.

In addition to the rigid connections 152 between the machine 100 and the trucks 146, 148 of the disclosed stabilization trains, the dry additive supply line 132 and the water supply line 136 that supply dry additive and water, respectively, to the stabilization machine 100 are also illustrated in FIGS. 3-8. As described above, the supply lines 132, 136 may be any type of conduit known in the art capable of delivering dry additive and water to the stabilization machine 100. For example, flexible hose or tubular material like that illustrated in FIGS. 3-8 may be employed. The supply lines 132, 136 may be coupled at the front or rear end of the stabilization machine 100. For example, as illustrated in FIG. 3, the dry additive supply line 132 is coupled to the rear end of the machine 100, while the water supply line 136 is couple to the front end of the machine 100. Alternatively, in the stabilization train of FIG. 4, wherein the order of the trucks 146, 148 is reversed, the opposite configuration of the supply lines 132, 136 may be employed.

Depending on the organization of the stabilization train, both of the supply lines 132, 136 may be coupled at either the front or rear end of the stabilization machine 100. For example, as illustrated in FIGS. 5 and 6, where the machine 100 is positioned in front of both storage trucks 146, 148, both of the supply lines 132, 136 are coupled to the rear end of the machine 100. Alternatively, as illustrated in FIGS. 7 and 8, where the machine 100 is positioned behind both storage trucks 146, 148, both of the supply lines 132, 136 are coupled to the front end of the machine 100. In the stabilization trains of FIGS. 5-8, where the machine 100 is positioned at the front or rear end of the stabilization train, a longer supply line 132, 136 may be required for the storage truck 146, 148 positioned furthest away from the machine 100. For example, for the stabilization trains of FIGS. 5 and 7 a dry additive supply line 132 that is long enough to extend from the dry additive storage truck 146 to the water storage truck 148 and then ultimately to the stabilization machine 100 is required. Likewise, for the stabilization trains of FIGS. 6 and 8, a water supply line 136 that is long enough to extend from the water storage truck 148 to the dry additive storage truck 146 and then ultimately to the stabilization machine 100 is required. Therefore, in such stabilization trains, as illustrated in FIGS. 5-8, the machine 100 may include at least the following coupled to either a front or rear end of the machine 100: rigid connection 152, dry additive supply line 132 and water supply line 136. In any case, because the machine 100 and the trucks 146, 148 may be spaced apart from one another at a set length in a stabilization train (based on the length of the rigid connection 152 and the length of the trucks 146, 148), and because the machine 100 and the trucks 146, 148 of the stabilization train advance forward at the same speed, no manipulation of the length of the supply lines 132, 136 is required in the disclosed stabilization systems during the stabilization process.

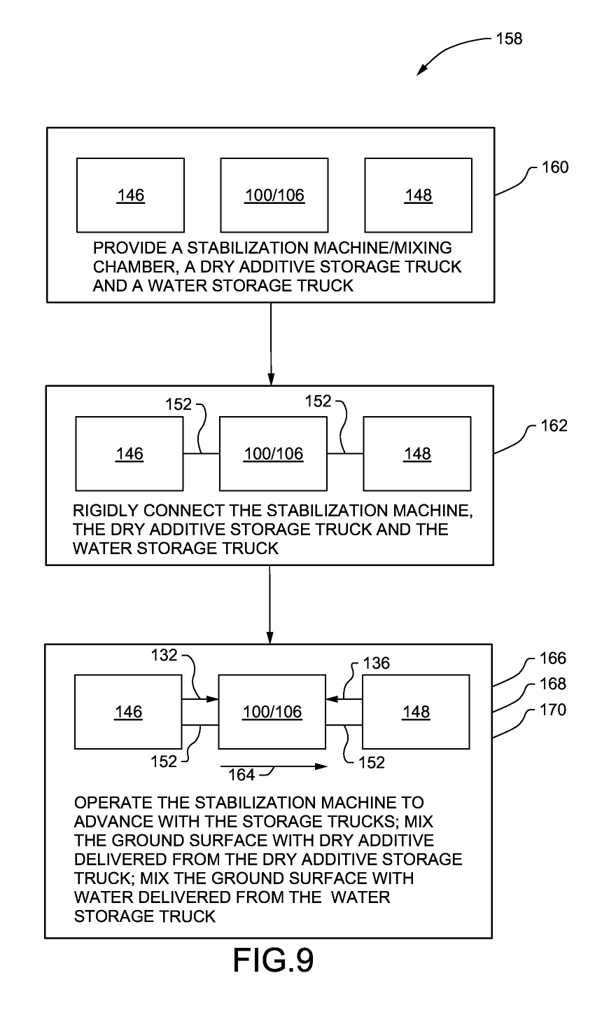

FIG. 9 is a block diagram illustrating a method 158 for soil stabilization of a ground surface 116 according to the teachings of the present disclosure. With reference to the drawings generally, the method 158 for soil stabilization may include: a first step 160 of providing a stabilization machine 100 having a mixing chamber 106, a dry additive storage truck 146 and a water storage truck 148; and a second step 162 of rigidly connecting the stabilization machine 100 to the dry additive storage truck 146 and the water storage truck 148. Thereafter, the method 158 for soil stabilization may include the steps 166, 168, 170 of: operating the stabilization machine 100 to engage the ground surface 116 beneath the mixing chamber 106 and to travel simultaneously with the dry additive and water storage trucks 146, 148 over the ground surface 116 (step 166); mixing the ground surface 116 with dry additive delivered directly from the dry additive storage truck 146 to the mixing chamber 106 (step 167); and mixing the ground surface 116 with water delivered directly from the water storage truck 148 to the mixing chamber 106 (step 166).

As depicted in FIG. 9 and detailed herein, the step 162 of rigidly connecting the stabilization machine 100, the dry additive truck 146 and the water storage truck 148 may include rigid connections 152 between the machine 100 and trucks the 146, 148. Multiple arrangements of the machine 100 and trucks the 146, 148 are detailed above and illustrated in FIGS. 3-8. The following steps 166, 168, 170, which may or may not be simultaneously executed, may include advance movement or travel 164 of the machine 100 and the trucks 146, 148 together due to the rigid connections 152 there between; mixing of the ground surface 116 with dry additive may include usage of the dry additive supply line 132 between the dry additive storage truck 146 and the machine 100; and mixing of the ground surface 116 with water may include usage of the water supply line 136 between the water storage truck 148 and the machine 100. This disclosed method of soil stabilization 158 may result in advance movement of the machine 100 and the trucks 146, 148 simultaneously at the same speed and at a fixed distance there between during a soil stabilization process.

While the above detailed description and drawings are made with reference to a soil stabilization system and method, it is important to note that the teachings of this disclosure can be employed on other machines and methods used in construction, agriculture and industrial environments or any other applications where stabilization machines may be employed.

### INDUSTRIAL APPLICABILITY

In operation, the present disclosure can find application in any number of different industries, such as but not limited to machines for stabilizing soil prior to road construction or the like. Indeed, soil stabilization of a ground surface is oftentimes required before any road or building construction on the ground surface may proceed. The present disclosure may improve upon existing soil stabilization processes with regard to worksite dust control, dry additive loss, time loss, energy efficiency and personnel efficiency.

Referring to the drawings generally, a disclosed system and method for soil stabilization may include a stabilization machine 100, a dry additive storage truck 146 and a water storage truck 148. Similar to conventional soil stabilization systems, the presently disclosed system includes the mixing of the base material 114 with dry additive 120 and water 122. Because of the generally light and powdery nature of dry additives such as fly ash, lime and cement, conventional means employing dry additives in soil stabilization processes generate significant amounts of dust at the worksite, resulting in undesirable working conditions for the personnel, as well as for the equipment being used. Windy conditions exacerbate these problems and may also cause significant dry additive loss.

The presently disclosed soil stabilization system and method may avoid excessive dust at a worksite by directly delivering dry additive to the mixing chamber 106 of a stabilization machine 100, thereby resulting in immediate mixing of the dry additive with the subject base material 114. In addition, the disclosed system may include the simultaneous delivery of water 122 to the mixing chamber 106, further aiding in dust control by binding with the dry additive, as well as aiding in the mixing process by wetting the base material 114 to be stabilized. In operation, the dry additive 120 and water 122 supplied from the dry additive storage truck 146 and the water storage truck 148 are delivered directly into the mixing chamber 106 of the machine 100 via the dry additive supply line 132 and delivery system 130, and the water supply line 136 and delivery system 134, respectively. Within the mixing chamber 106, the base material 114 is upwardly displaced by the rotor 110 and is simultaneously pulverized and mixed with the dry additive 120 and water 122. In this manner, the dusty conditions associated with conventional stabilization processes are avoided. Moreover, because dry additive is delivered directly to the mixing chamber 106 and thereafter combined with the base material 114, the unwanted loss of the dry additive is avoided.

The presently improved soil stabilization system and method may further include a stabilization train as described herein and depicted in FIGS. 3-8. Such a stabilization train may comprise an interconnected combination of the stabilization machine 100, the dry additive storage truck 146 and the water storage truck 148. Specifically, in addition to the supply lines 132, 136 between the machine 100 and the storage trucks 146, 148, the stabilization train includes rigid connections 152 between the machine 100 and the storage trucks 146, 148. In operation, the machine 100 and the storage trucks 146, 148 advance forward together, the storage trucks 146, 148 capable of continuously supplying dry additive and water to the mixing chamber 106 of the machine 100 during the stabilization process. As opposed to conventional stabilization systems that require refilling of built-in dry additive containers, and therefore, multiple interruptions to the stabilization process; the presently disclosed system allows for a continuous supply of a large volume of dry additive and water to the mixing chamber 106 of the stabilization machine 100 thereby eliminating any interruptions to the stabilization process.

The stabilization train of the present disclosure may also conserve energy in comparison to conventional stabilization processes. Specifically, due to the rigid connections 152, forward movement of the stabilization train may be effectuated by operation of the stabilization machine 100 alone. For example, the forward movement of the stabilization machine 100 may push or pull (depending on the machine 100 placement in the train) the rigidly connected dry additive storage truck 146 and the water storage truck 148. In this manner, the additional energy consumption associated with independently operating the dry additive storage truck 146 and water storage truck 148 is avoided. Likewise, the additional personnel and/or drivers that are required when independently operating the dry additive storage truck 146 and the water storage truck 148 may not be required in the presently disclosed stabilization processes.

The stabilization system and method of the present disclosure may also offer the advantages of regulated speed and fixed distances between the stabilization machine 100 and the storage trucks 146, 148. Because the rigid connections 152 maintain the machine 100 and trucks 146, 148 in a stabilization train wherein the machine 100 and the trucks 146, 148 all advance together, all advance at the same speed. This configuration therefore avoids the need for any additional operator or driver for managing the speed between moving components. Moreover, the machine 100 and the trucks 146, 148 may be maintained at specific, fixed distances from one another in the stabilization train. In this manner, the length of the supply lines 132, 136 between the storage trucks 146, 148 and the stabilization machine 100 may also be fixed. Therefore, the presently disclosed stabilization system and methods avoid any need for manipulation of the lengths of the supply lines 132, 136, as well as the energy and personnel that such manipulation may require.

The present disclosure thus provides an altogether new strategy for soil stabilization. While the method of mixing of dry additives and water with base material to be stabilized has previously been known and performed, prior methods have not offered the advantages of the presently disclosed system and methods. Specifically, the dusty conditions associated with the prior methods compromise the working conditions for both the personnel and the equipment at a worksite, therefore compromising the quality of the stabilization process and possibly endangering the personnel. In the context of soil stabilization, the present disclosure offers a far more efficient system and method wherein dust production may be more adequately controlled and the energy, time and personnel required may be significantly reduced.

All references to the disclosure or examples thereof are intended to reference the particular example being discussed at that point and are not intended to imply any limitation as to the scope of the disclosure more generally. Additionally, those skilled in the art will appreciate that various modifications might be made to the presently disclosed embodiments without departing from the full and fair scope of the present disclosure.

What is claimed is:

1. A soil stabilization machine configured to mix a ground surface with dry additive and water, the machine comprising:
a machine frame;
a plurality of traction units configured to support the machine frame on the ground surface;
a rotor coupled to the frame between traction units and configured to engage the ground surface;
a mixing chamber coupled to the frame and at least partially defined by a hood, the mixing chamber at least partially surrounding the rotor;
a dry additive delivery system configured to blow a metered amount of dry additive under the hood and directly into the mixing chamber from a dry additive storage truck; and
a water delivery system configured to deliver a metered amount of water directly into the mixing chamber from a water storage truck.

2. The soil stabilization machine of claim 1, wherein the dry additive delivery system and the water delivery system are supported on the hood of the mixing chamber.

3. The soil stabilization machine of claim 1, wherein the dry additive delivery system and the water delivery system each include a metering device for controlling the amount of dry additive and water delivered to the mixing chamber.

4. The soil stabilization machine of claim 1, wherein the dry additive is fly ash, lime, cement or a combination thereof.

5. The soil stabilization machine of claim 1, wherein the machine frame is rigidly coupled to the dry additive storage truck and the water storage truck.

6. The soil stabilization machine of claim 5, wherein the machine frame is coupled to the dry additive storage truck and the water storage truck with one or more rigid connections.

7. The soil stabilization machine of claim 1, wherein the machine frame is adapted to receive one or more rigid connections.

8. A soil stabilization system configured to mix dry additive and water with a ground surface, the system comprising:
a rotary mixer including a mixing chamber;
a dry additive storage truck;
a water storage truck;
a dry additive conduit for delivery of dry additive from the dry additive storage truck to the mixing chamber; and
a water conduit for delivery of water from the water storage truck to the mixing chamber, the rotary mixer, the dry additive storage truck and the water storage truck being rigidly connected.

9. The soil stabilization system of claim 8, wherein the rotary mixer, the dry additive storage truck and the water storage truck are connected in a generally front to back formation.

10. The soil stabilization system of claim 8, wherein the rotary mixer is positioned between the dry additive storage truck and the water storage truck.

11. The soil stabilization system of claim 8, wherein the rotary mixer, the dry additive storage truck and the water storage truck each include frames adapted to receive a rigid connection.

12. The soil stabilization system of claim 8, wherein the dry additive storage truck and the water storage truck are non-self-propelled.

13. The soil stabilization system of claim 8, wherein the mixing chamber comprises a dry additive delivery system and a water delivery system.

14. The soil stabilization system of claim 8, further comprising a dry additive metering device and a water metering device.

15. A method of soil stabilization of a ground surface, comprising:
providing a stabilization machine having a mixing chamber, a dry additive storage truck and a water storage truck;
rigidly connecting the stabilization machine, the dry additive storage truck and the water storage truck;
operating the stabilization machine to engage the ground surface beneath the mixing chamber and to advance forward simultaneously with the dry additive storage truck and water storage truck;
mixing the ground surface with a dry additive delivered from the dry additive storage truck to the mixing chamber; and
mixing the ground surface with water delivered from the water storage truck to the mixing chamber.

16. The method of claim 15, further comprising delivering the dry additive through a dry additive conduit between the dry additive storage truck and the stabilization machine; and delivering water through a water conduit between the water storage truck and the stabilization machine.

17. The method of claim 15, further comprising metering an amount of dry additive delivered to the mixing chamber; and metering an amount of water delivered to the mixing chamber.

18. The method of claim 15, wherein the stabilization machine, the dry additive storage truck and the water storage truck each advance forward at the same speed.

19. The method of claim 15, wherein each of the stabilization machine, the dry additive storage truck and the water storage truck are maintained at a fixed distance from each other.

20. The method of claim 15, wherein operating the stabilization machine, mixing the ground surface with a dry additive, and mixing the ground surface with water occur simultaneously.
